(19) United States
(12) Patent Application Publication
(10) Pub. No.: US 2007/0133811 A1
(43) Pub. Date: Jun. 14, 2007

(54) Sound source separation apparatus and sound source separation method

(75) Inventors: Hiroshi Hashimoto, Kobe-shi (JP); Takashi Hiekata, Kobe-shi (JP); Takashi Morita, Kobe-shi (JP); Yohei Ikeda, Kobe-shi (JP)

Correspondence Address: REED SMITH LLP, 3110 FAIRVIEW PARK DRIVE, SUITE 1400, FALLS CHURCH, VA, 22042, US

(73) Assignee: Kabushiki Kaisha Kobe Seiko Sho

(21) Appl. No.: 11/603,179

(22) Filed: Nov. 22, 2006

(30) Foreign Application Priority Data
Dec. 8, 2005 (JP) 2005-354585

(51) Int. Cl. H04R 5/00

(52) U.S. Cl. 381/22

(57) ABSTRACT

A sound source separation apparatus performs a temporary learning processing and a temporary separation processing with respect to each of a plurality of candidate matrixes (separating matrixes obtained by learning calculation based on input signals of different sound source conditions) stored on a candidate matrix memory in advance. The apparatus determines an initial matrix of the separating matrix based on the obtained correlation evaluation of the separated signals. The learning calculations of the initial matrix determination processing and separating matrix based on the initial matrix are performed at a time of the sound source separation processing by the apparatus and when a degree of correlation among the separated signals by a correlation evaluation part exceeds a predetermined level.

### BACKGROUND OF THE INVENTION

1. Field of the Invention

The present invention relates to a sound source separation apparatus and a sound source separation method.

2. Description of the Related Art

In a space where a plurality of sound sources and a plurality of microphones (sound input means) exist, to each microphone, sound signals (hereinafter, referred to as mixed sound signals) which are overlapped individual sound signals (hereinafter, referred to as sound source signals) from the plurality of sound sources are input. A method of sound source separation processing which identifies (separates) each of the sound source signals based on only thus input plurality of mixed sound signals is referred to as a Blind Source Separation Method (hereinafter, referred to as a BSS method).

Further, one of sound source separation processing of the BSS method, there is a sound source separation processing based on an Independent Component Analysis (hereinafter, referred to as an ICA). In the BSS method based on the ICA (hereinafter, referred to as ICA-BSS), by using the fact that each of the sound source signals are statistically independent each other, a predetermined separating matrix (inverse mixed matrix) is optimized. To the plurality of mixed sound signals input from the plurality of microphones, filter processing by the optimized separating matrix is carried out to identify the sound source signals (sound source separation). Then, the optimization of the separating matrix is carried out based on an identified (separated) signal (separated signal) identified by a filter processing by using a separating matrix set at a certain time, by calculating a separating matrix which is subsequently used by sequential calculation (learning calculation).

When the learning calculation is started, a separating matrix (hereinafter, referred to as initial matrix) to which a predetermined initial value is set is given, the initial matrix is updated by learning calculation and set as a separating matrix which is used for a sound source separation. Generally, at a first learning calculation start, a predetermined certain matrix is set as an initial matrix, and sequentially, each time the learning calculation is carried out, the learned separating matrix is set as an initial matrix for the next learning calculation start.

In the sound source separation processing based on the ICA-BSS method, if the sequential calculation (learning calculation) for obtaining a separating matrix is sufficiently carried out, a high sound source separation performance (an identification performance of the sound source signals) can be obtained. However, in order to obtain the high sound source separation performance, it is necessary to increase the number of times of the sequential calculations (learning calculations) for obtaining a separating matrix used for a separation processing (filter processing). Then, the operation load increases and if the calculation is carried out by a practical processor, it takes severalfold of time as compared with a time length of mixed sound signals to be input. As a result, even if real time processing of the sound source separation processing itself is possible, the update cycle (learning cycle) of the separating matrix used for the sound source separation processing becomes long and it is not possible to immediately respond to a change of acoustic environment.

Especially, for a certain time after the start of the processing or in a case in which an acoustic environment is changed (sound source is moved, sound source is added or changed, etc.), a separating matrix (that is, initial matrix) at the time of learning calculation start is not suited for the state of the sound source at the time. In such a case, in order to obtain a sufficient sound source separation performance (sufficiently converging the learned result), the operation load of the separating matrix increases. Further, if the initial matrix is not suited for the state of the sound source at the time, the learned result of the separating matrix results in a local solution. Accordingly, even if the learning calculation is converged, the sufficient sound source separation performance may not be obtained.

### SUMMARY OF THE INVENTION

Accordingly, it is an object of the present invention to provide a sound source separation apparatus and a sound source separation method capable of increasing sound source separation performance as mush as possible while a load of operating separating matrix is reduced so that real time processing can be carried out when a sound source separation processing based on the ICA-BSS method is carried out even for a certain time after the start of the processing or even if an acoustic environment is changed.

The present invention is applied to a sound source separation apparatus and a sound source separation method. A feature of the present invention is directed to carry out each processing by means corresponding each processing or instruct a computer to carry out the processing that a plurality of sound input processing for receiving a plurality of mixed sound signals, sound source signals from a plurality of sound sources being overlapped in each of the mixed sound signals; storage processing for storing in advance a plurality of candidate matrixes to which predetermined matrix elements are set; initial matrix determination processing for determining an initial matrix used for a learning calculation of a separating matrix by a blind source separation based on independent component analysis according to the plurality of the candidate matrixes, separating matrix initial learning processing for performing the learning calculation of the separating matrix by using the initial matrix and the plurality of mixed sound signals of a predetermined time length, and sequential sound source separation processing for sequentially generating a plurality of separated signals corresponding to the sound source signals by performing a matrix calculation using the separating.

As described above, a certain time after the start of the processing or even if an acoustic environment is changed (a sound source is moved, added or changed, etc.), in order to obtain a sufficient sound source separation performance, the operation load of the separating matrix becomes higher. However, on the contrary, if the initial matrix (the separating matrix to which the initial value of the learning calculation start is set) corresponding to the acoustic environment status can be given, the number of times of sequential calculations (the number of times of learning) necessary to converge the separating matrix can be reduced. Further, it can be prevented that the learned result of the separating matrix results in a local solution.

Accordingly, as in the present invention, based on the plurality of candidate matrixes stored in advance, if an initial matrix corresponding to a status of the time is determined, while the number of times of sequential calculations necessary to converge the separating matrix can be reduced, it can be prevented that the learned result of the separating matrix resulting in the local solution. As a result, while the operation load of the separating matrix is reduced, the sound source separation performance can be increased as much as possible.

For example, it is preferable when determining an initial matrix corresponding to each of expected sound source conditions if the plurality of candidate matrixes to be stored in advance are separating matrixes obtained by learning calculation based on the ICA-BSS method using the mixed sound signals in each of a plurality of acoustic spaces in which the sound source conditions (positions, the number, types of sound source, etc.) differ.

As for further specific contents of the initial matrix determination processing, it can be considered that temporary separating matrix calculation processing for calculating temporary separating matrixes by performing learning calculations of the separating matrixes according to the blind source separation based on independent component analysis using the candidate matrixes and the plurality of the mixed sound signals of a predetermined time length with respect to each of the plurality of the candidate matrixes is carried out, temporary sound source separation processing for generating a plurality of temporary separated signals corresponding to the sound source signals from the plurality of the mixed sound signals by matrix calculations using the temporary separating matrixes with respect to each of the temporary separating matrixes and a first correlation evaluation processing for evaluating a degree of correlation among the plurality of the temporary separated signals generated by the temporary sound source separation means with respect to each of the temporary separating matrixes are carried out. Then, based on an evaluation result of the first correlation evaluation processing, a matrix to be the initial matrix from the plurality of the candidate matrixes or the temporary separating matrixes corresponding to each of the candidate matrixes is selected (that is, determined as the initial matrix).

Generally, the higher the separation performance of sound source separation is, the lower the correlation among a plurality of output separated signals becomes.

Accordingly, if the candidate matrix or the temporary separating matrix corresponding to the candidate matrix is selected as the initial matrix, the (high sound source separation performance) initial matrix corresponding to the status of the time can be determined.

In the temporary separating matrix calculation processing, because learning calculation is performed to each of the plurality of the candidate matrixes, the learning calculation is required to be easy calculation in order to reduce the operation load. For example, if the time length of the mixed sound signals used by the temporary separating matrix calculation means is set to be shorter than the time length of the mixed sound signals used by the separating matrix calculation means, the operation load is reduced and thus preferable.

Further, if means for storing the plurality of the mixed sound signals of the predetermined time length (mixed sound signal storage means) is provided and in the temporary separating matrix calculation processing, the temporary separating matrix is calculated by using the same mixed sound signals stored on the mixed sound signals storage means with respect to each of the plurality of the candidate matrixes, premise conditions for comparing evaluated results of correlation degree are satisfied and thus preferable.

Further, the initial matrix determination processing and the separating matrix initial learning processing can be carried out at least a sound source separation processing by the sound source separation apparatus (or the sound source separation program, the sound source separation method) is started. In addition, it is possible to perform the second correlation evaluation processing to evaluate a degree of correlation among the separated signals generated by the sequential sound source separation processing, and based on an evaluation result, perform the separating matrix initialization processing to perform the initial matrix determination processing and the separating matrix initial learning.

As described above, generally, after the separating matrix is obtained by the first learning calculation, the learned separating matrix is set as an initial matrix in the next learning calculation.

On the other hand, while the sound source separation processing is executed, if a result that a degree of correlation among the separated signals exceeds the predetermined level is obtained by the second correlation evaluation processing, it is assumed that the learning calculation of the separating matrix results in a local solution due to a change of the status of the acoustic space (status of the sound source). In such a case, if the separating matrix initialization processing is performed, an (high sound source separation performance) initial matrix corresponding to a new status of the acoustic space can be determined again. As a result, it can be prevented that the learned result of the separating matrix results in the local solution if the change in the acoustic environment is changed, and the sound source separation performance can be increased as much as possible.

According to the present invention, a certain time after the start of the processing or if an acoustic environment is changed (a sound source is moved, added or changed, etc.), the initial matrix (the separating matrix to which the initial value of the learning calculation start is set) corresponding to the acoustic environment status can be given. Accordingly, while the number of times of sequential calculations necessary to converge the separating matrix can be reduced, it can be prevented that the learned result of the separating matrix resulting in a local solution. As a result, while the operation load of the separating matrix is reduced, the sound source separation performance can be increased as much as possible and thus, suitable for real time sound source separation.

### BRIEF DESCRIPTION OF THE DRAWINGS

FIG. 1 is a block diagram illustrating a schematic configuration of a sound source separation apparatus X according to an embodiment of the present invention;

FIG. 2 is a timing chart illustrating an execution timing of each processing carried out by the sound source separation apparatus X;

FIG. 3 is a block diagram illustrating a schematic configuration of a sound source separation apparatus Z1 which carries out sound source separation processing in the BBS method based on a TDICA method; and

FIG. 4 is a block diagram illustrating a schematic configuration of a sound source separation apparatus Z2 which carries out sound source separation processing in the BBS method based on a FDICA method.

### DESCRIPTION OF THE PREFERRED EMBODIMENTS

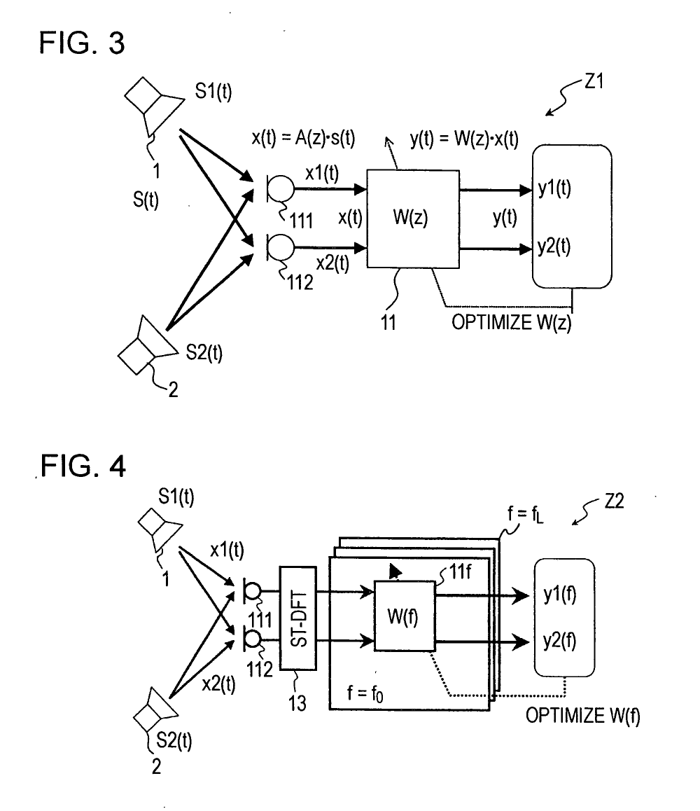

First, in advance of describing embodiments of the present invention, with reference to block diagrams shown in FIGS. 3 and 4, examples of a sound source separation apparatus based on various ICA-BSS methods applicable as a constituent element in the present invention are described.

It is assumed that sound source separation processing or apparatuses which carry out the processing described below are in a state that a plurality of sound sources and a plurality of microphones (sound input means) exist in a predetermined acoustic space. Further, these examples relate to sequential sound source separation processing or an apparatus which carries out the processing to generate a plurality of separated signals (signals which identified sound source signals) corresponding to the sound source signals by carrying out matrix calculation using a predetermined separating matrix to a plurality of mixed sound signals which are overlapped individual sound signals (hereinafter, referred to as sound source signals) from each of the sound sources input through each of the microphones.

FIG. 3 is a block diagram illustrating a schematic configuration of a known sound source separation apparatus Z1 which carries out sound source separation processing in a BSS method based on a Time-Domain Independent Component Analysis method (hereinafter, referred to as TDICA method) which is one of the ICA methods.

To the sound source separation apparatus Z1, through two microphones (sound input means) 111 and 112, sound source signals S1(t) and S2(t) (sound signals of each sound source) are input from two sound sources 1 and 2. Then, in a separating filter processing part 11, a sound source separation processing is carried out by performing a filter processing by a separating matrix W (z) to mixed sound signals x1(t) and x2(t) of two channels (the number of microphones). In FIG. 3, the example of two channels is shown, however, channels more than one channel can be used. In the case of sound source separation in the ICA-BSS method, the following condition is satisfied; (the number of channels n of mixed sound signals to be input ((that is, the number of microphones))≧(the number of sound sources m).

In each of the mixed sound signals x1(t) and x2(t) which is collected through each of the plurality of microphones 111 and 112, sound source signals from the plurality of sound sources are overlapped. Hereinafter, each of the mixed sound signals x1(t) and x2(t) is genetically referred to as x(t). The mixed sound signal x(t) is expressed as a temporal-special convolution signal of a sound source signal S(t), and given as the following formula 1:
x(t)=A(z)·s(t) (1)
where A(z) represents a spatial matrix used when signals from the sound sources are input to the microphones.

The theory of sound source separation in the TDICA method uses the fact that each sound source of the sound source signal S(t) is statistically independent each other. That is, if x(t) is given, S(t) can be estimated, thus, it is possible to separate sound sources.

If it is assumed that a separating matrix used for the sound source separation processing is W(z), the separated signal (that is, identified signal) y(t) is given as the following formula:
y(t)=W(Z)·x(t) (2)

W(z) is obtained by output y(t) by sequential calculation (learning calculation) and the separated signal can be obtained the same number of the channels.

Sound synthesis processing can be carried out based on information about W(z) by creating an array corresponding to an inverse operation processing and carrying out an inverse operation by using the array. As an initial value (initial matrix) of the separating matrix used when carrying-out the sequential calculation of the separating matrix W(z), a predetermined initial value is set.

By carrying out the above-described sound source separation based on the ICA-BSS method, for example, from mixed sound signals of a plurality of channels in which human singing voice and sound of instrument such as a guitar is mixed, a sound source signal of the singing voice and a sound source signal of the instrument are separated (identified).

The formula 2 can be given as the following formula 3:

$$y ( t ) = {\sum }_{n = 0}^{D - 1} w ( n ) x ( t - n ) \qquad ( 3 )$$

where D denotes the number of taps of the separating filter W(n).

The separation filter (separating matrix) W(n) in the formula 3 is sequentially calculated according to the following formula 4. That is, by sequentially applying the output y(t) of previous (j) to the formula 4, this time, W(n) of (j+1) is obtained.

$${w}^{[ j + 1 ]} ( n ) = {w}^{[ j ]} ( n ) - α {\sum }_{d = 0}^{D - 1} \{ off - diag {〈 φ ( {y}^{[ j ]} ( t ) ) {{y}^{[ j ]} ( t - n + d )}^{T} 〉}_{t} \} \cdot {w}^{[ j ]} ( d ) \qquad ( 4 )$$

where α denotes the update coefficient, [j] denotes the number of updates, < . . . >ₜ denotes a time-averaging operator, “off-diag X” denotes the operation to replace all the diagonal elements in the matrix X with zeros, and φ( . . . ) denotes an appropriate nonlinear vector function having an element such as a sigmoidal function.

With reference to the block diagram shown in FIG. 4, a known sound source separation apparatus Z2 which carries out sound source separation processing based on a FDICA (Frequency-Domain ICA) method which is one of the ICA methods is described.

In the FDICA method, first, with respect to input mixed sound signals x(t), a Short Time Discrete Fourier Transform (hereinafter, referred to as ST-DFT processing) is carried out to each frame which is a signal divided into each predetermined cycle by a ST-DFT processing part 13, and short time analysis of the observation signals is carried out. Then, with respect to the signals (signals of each frequency component) of each channel after the ST-DFT processing, by carrying out a separation filter processing based on the separating matrix W(f) by a separation filter processing part 11f, the sound source separation (identification of the sound source signals) is performed. If it is assumed that f is a frequency band, and m is an analysis frame number, the separated signal (identified signal) y(f, m) is given as the following formula 5:
Y(f,m)=W(f)·X(f,m) (5)

An update formula of the separation filter W(f) is given, for example, as the following formula 6:

$${W}_{( ICAl )}^{[ i + 1 ]} ( f ) = {W}_{( ICAl )}^{[ i ]} ( f ) - η ( f ) [ off \text{-} diag \{ {〈 φ ( {Y}_{( ICAl )}^{[ i ]} ( f , m ) ) {{Y}_{( ICAl )}^{[ i ]} ( f , m )}^{H} 〉}_{m} \} ] {W}_{( ICAl )}^{[ i ]} ( f ) \qquad ( 6 )$$

where η(f) denotes the update coefficient, i denotes the number of updates, < . . . > denotes a time-averaging operator, H denotes the Hermitian transpose, “off-diag X” denotes the operation to replace all the diagonal elements in the matrix X with zeros, and φ( . . . ) denotes an appropriate nonlinear vector function having an element such as a sigmoid function.

According to the FDICA method, the sound source separation processing is dealt with as an instantaneous mixing problem in each narrow band, and the separation filter (separating matrix) W(f) can be relatively easily and stably updated.

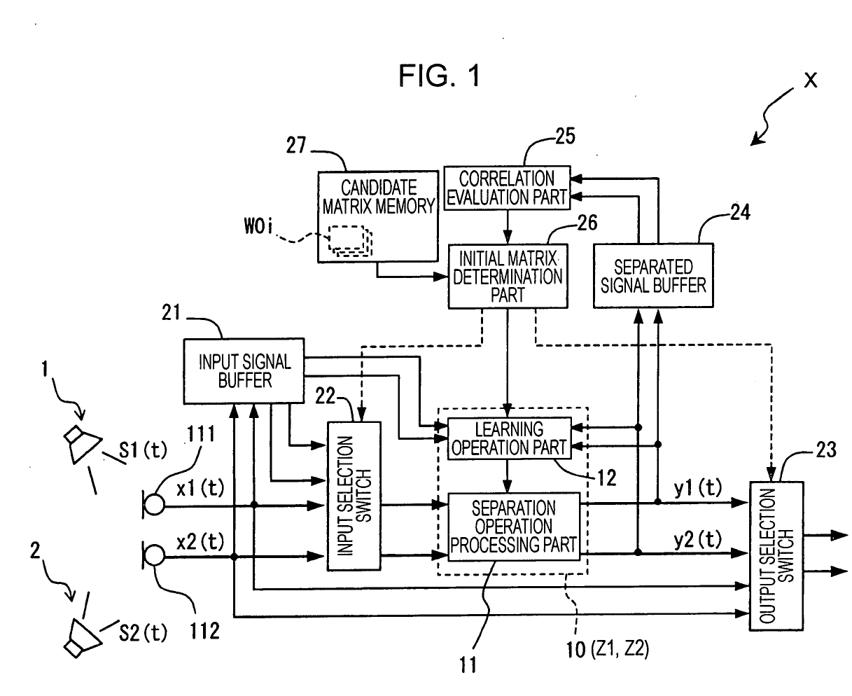

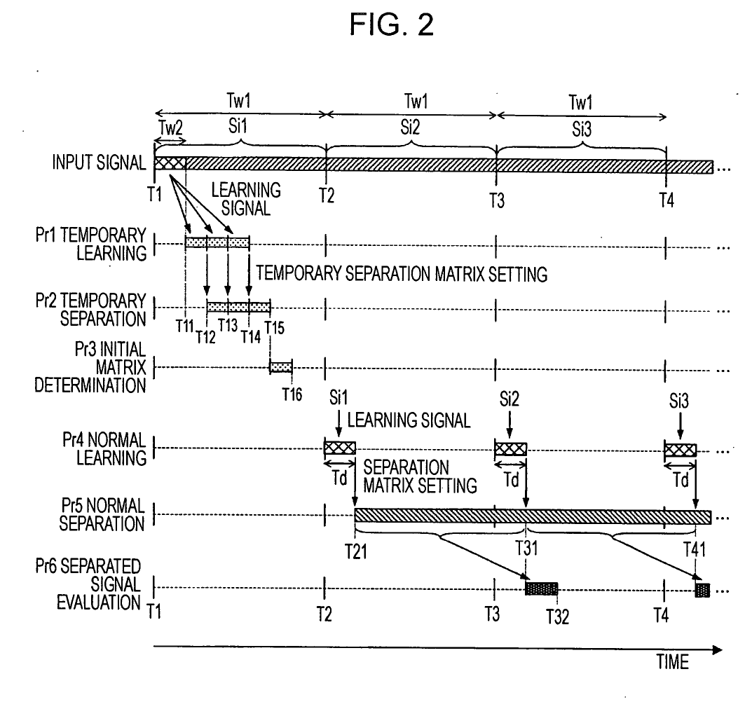

### First Embodiment (See FIGS. 1 and 2)

With reference to a block diagram shown FIG. 1, a sound source separation apparatus X according to an embodiment of the present invention is described.

The sound source separation apparatus X, in a state that a plurality of sound sources 1 and 2 and a plurality of microphones 111 and 112 (sound input means) exist in an acoustic space, from a plurality of mixed sound signals xi(t) which are overlapped sound source signals (individual sound signals) sequentially input from each of the sound sources 1 and 2 through each of the microphones 111 and 112, sequentially generates separated signals (that is, identified signals corresponding to the sound source signals) y which are separated (identified) sound source signals (individual sound signals) and outputs to a speaker (sound output means) in real time. The sound source separation apparatus X is applicable, for example, to a hands-free telephone, a sound collecting device for teleconference, a sound input apparatus for car navigation systems, or the like.

As shown in FIG. 1, the sound source separation apparatus X includes a separation operation processing part 11, a learning operation part 12, an input signal buffer 21, an input selection switch 22, an output selection switch 23, a correlation evaluation part 25, an initial matrix determination part 26, and a candidate matrix memory 27. A sound source separation device 10 includes the learning operation part 12 and the separation operation processing part 11.

Each constituent element in the sound source separation device 10, the correlation evaluation part 25, and the initial matrix determination part 26 can include a DSP (Digital Signal Processor) or a CPU and its peripheral devices (ROM, RAM, or the like) and a program which is executed by the DSP or the CPU, respectively. Alternatively, a program module which executes processing of each constituent element can be configured in a computer which has a CPU and its peripheral devices. Further, it is also possible to provide each constituent element as a sound source separation program which instructs a predetermined computer to execute processing of each constituent element.

FIG. 1 shows an example that the number of channels (that is, the number of microphones) of the mixed sound signals xi(t) to be input is two. However, if (the number of channels n)≧(the number of sound sources m) is satisfied, even if more than two channels, a similar configuration can be realized.

The candidate matrix memory 27 is a storage means for storing in advance a plurality of matrixes (hereinafter, referred to as candidate matrixes Woi) to which a predetermined value (value of matrix element) is set. The candidate matrix Woi has a similar configuration to the separating matrix W used in the sound source separation device 10. The candidate matrix memory 27 includes a nonvolatile storage means such as a ROM.

A plurality of candidate matrixes Woi which are stored on the candidate matrix memory 27 in advance are separating matrixes obtained from learning calculation of the ICA-BSS sound source separation processing by the sound source separation device 10 using mixed sound signals xi(t) of a plurality of cases in which conditions of the sound sources 1 and 2 differ.

As the conditions of the sound sources, for example, relative positions (set directions or distances) of each of the sound sources 1 and 2 to the microphones 111 and 112, types or numbers of sound sources 1 and 2, or the like can be considered. One specific example is that a combination of set directions (angles of set positions) θ1 and θ2 of each of the sound sources 1 and 2 to the front direction of the microphones 111 and 112 is (θ1, θ2)=(0°, 60°), (60°, 60°), (60°, 0°). As described above, in the case in which the plurality of cases in which conditions of the sound sources 1 and 2 differ, the separating matrixes W obtained from learning calculation of the ICA-BSS sound source separation processing by the sound source separation device 10 is stored as the candidate matrixes Woi on the candidate matrix memory 27 in advance.

The initial matrix determination part 26 is a means for performing a processing (hereinafter, referred to as initial matrix determination processing) for determining an initial matrix of the separating matrix W based on the plurality of the candidate matrixes Woi (an example of the initial matrix determination means). The initial matrix is used for a learning calculation of the separating matrix W by the ICA-BSS sound source separation processing (learning calculation carried out by the learning operation part 12) in the sound source separation device 10.

The separation operation processing part 11 is a means for performing a sound source separation processing (sequential sound source separation processing) for sequentially generates a plurality of separated signals yi(t) corresponding to each of sound source signals Si(t) (an example of the sequential sound source separation means). The separated signal yi(t) is generated by carrying out a matrix calculation using the separating matrix W to each of the mixed sound signals xi(t) sequentially input through each of the microphones 111 and 112.

The learning operation part 12 is a means for sequentially calculating the separating matrix W used in the separation operation processing part 11. The separating matrix W can be obtained by carrying out a learning calculation of a separating matrix W by the ICA-BSS sound source separation processing by using a plurality of mixed sound signals xi(t) having a predetermined time length. The mixed sound signal xi(t) is digitized by sampling by a predetermined cycle. Accordingly, defining the time length of the mixed sound signal xi(t) has the same meaning with defining the number of samples of the digitized mixed sound signal xi(t).

If an initial matrix is determined by the initial matrix determination part 26, the learning calculation part 12 carries out a learning calculation of the separating matrix W by using the determined initial matrix and a plurality of the mixed sound signals xi(t) having the predetermined time length (an example of separating matrix initial learning means). In other cases, the learned separating matrix W which is obtained from the previous learning calculation is used as an initial matrix of the time.

As examples of the sound source separation processing (matrix calculation processing) using the separating matrix calculation (learning calculation) and the separating matrix in the sound source separation device 10, the sound source separation processing by the BSS method based on the TDICA method shown in FIG. 3 and the sound source separation processing by the BSS method based on the FDICA method shown in FIG. 4 are shown.

The correlation evaluation part 25 is a means for evaluating degree of correlation among a plurality of separated signals yi(t) generated by the separation operation processing part 11.

In this embodiment, the determination processing of an initial matrix by the initial matrix determination part 26 and the learning calculation (initial learning of the learning operation part 12) of a separating matrix W based on the initial matrix are carried out if it is determined that the sound source separation is not sufficient. For example, at a time of start of a sound source separation processing by the sound source separation apparatus X, or in a case in which a degree of correlation among separated signals yi(t) by the correlation evaluation part 25 exceeds a predetermined level (the correlation is high).

The input signal buffer 21 is a means (an example of the mixed sound signal storage means) for temporarily stores each of mixed sound signals xi(t) of a predetermined time length. The separated signal buffer 24 is a means for temporarily stores separated signals yi(t) of a predetermined time length.

The input selection switch 22 is a means for switching mixed sound signals to be input (to be a target of the separation operation processing) to the separation operation processing part 11 between real-time mixed sound signals sequentially input from the microphones 111 and 112 and mixed sound signals which are temporarily stored on the input signal buffer 21. The initial matrix determination part 26 performs the switching control (control of signal selection).

The output selection switch 23 switches whether the separated signals yi(t) generated by the separation operation processing part 11 is to be external output signals or whether the mixed sound signals xt(t) input form the microphones 111 and 112 themselves to be the external output signals. The initial matrix determination part 26 controls the switching.

With reference to the time chart in FIG. 2, a procedure of the sound source separation processing in the sound source separation apparatus X is described. It is assumed that the sound source separation apparatus X is built in another device such as a hands-free telephone and an operation status of an operation part such as an operation button which is provided to the device is acquired by a control part (not shown). Further, it is assumed that the sound source separation apparatus X starts the sound source separation processing if a predetermined processing start operation (start instruction) from the operation part is detected, and the sound source separation processing is finished if a predetermined end operation (end instruction) is detected.

First, if the start instruction is detected, the input signal buffer 21 starts to temporarily store input signals (mixed sound signals xi(t)) of an amount of a predetermined time length Tw1. Subsequently, in the input signal buffer 21, the latest input signals of the amount of the time length Tw1 are always stored (temporarily stored). Hereinafter, the time length Tw1 is referred to as a first set time length Tw1.

On the other hand, after the sound source separation processing is started (at the time of time T1), at a time when input signals of an amount of a predetermined time length Tw2 (<Tw1) which is shorter than the first set time length Tw1 are stored in the input signal buffer 21 (at the time of time T2), the learning operation part 12 starts a temporary learning processing Pr1. Hereinafter, the time length Tw2 is referred to as a second set time length Tw2.

In the temporary learning processing Pr1, the learning operation part 12 (an example of the temporary separating matrix calculation means) carries out a learning calculation of a separating matrix W based on the ICA-BSS sound source separation method, and the separating matrix W obtained as a result of the learning calculation is calculated as a temporary separating matrix (an example of a temporary separating matrix calculation processing, the period of time from T11 to T14 in the drawing). For the learning calculation of the separating matrix W, as an initial matrix, the plurality of the candidate matrixes Woi stored on the candidate matrix memory 27 in advance, and as the learning signal, the plurality of input signals (mixed sound signals xi(t)) of the amount of the second set time length Tw2 stored on the input signal buffer 21 are used.

Further, in this embodiment, as the learning signal in the temporary learning processing Pr1, the same mixed sound signals xt(t) stored on the input signal buffer (mixed sound signal storage means) are used. In the learning operation part 12, with respect to each of the plurality of the candidate matrixes Woi, the temporary separating matrix is calculated.

In parallel with the temporary learning processing Pr1 by the learning operation part 12, each time the temporary separating matrix is calculated, the separation operation processing part 11 (and example of the temporary sound source separation means) carries out a temporary separation processing Pr2 using each of the temporary separating matrix.

In the temporary separation processing Pr2, to the plurality of input signals (mixed sound signals xi(t)) of the amount of the second set time length Tw2 stored on the input signal buffer 21, with respect to each of the temporary separating matrix, a matrix calculation using each of the temporary separating matrix is carried out. Thus, a plurality of temporary separated signals corresponding to the sound source signals Si(t) are generated (the period of time from T12 to T15 in the drawing). Then, with respect to all of the candidate matrixes Woi stored in advance, as a result of the sound source separation processing using the temporary separating matrixes obtained by the learning calculation using the candidate matrixes Woi as initial matrixes, the temporary separated signals are obtained.

With respect to separated signals (the temporary separated signals are included) generated by the temporary separation processing Pr2 and a normal separation processing Pr5 which is described below, by the separated signal buffer 24, a temporarily storage of an amount of a predetermined time length (for example, an amount of the first set time length Tw1) is started. Subsequently, in the separated signal buffer 24, the latest separated signals of the predetermined time length are always stored (temporarily stored).

During the execution of the temporary separation processing Pr2, the input selection switch 22 is set (controlled) so that the signals stored in the input signal buffer 21 are input to the separation operation processing part 11. Further, during the execution of the temporary separation processing Pr2, in order that the input signals (mixed sound signals xi(t)) are externally output without change instead of the separated signals, the output selection switch 23 is set (controlled). This is because sound signals which are not related to the sound source signals at the time of the execution of the temporary separation processing Pr2 at all are generated as the separated signals.

Then, the correlation evaluation part 25 and the initial matrix determination part 26 carry out an initial matrix determination processing Pr3 (the period of time from T15 to T16 in the drawing).

In the initial matrix determination processing Pr3, first, the correlation evaluation part 25 (an example of the first correlation evaluation means), with respect to each of the temporary separating matrixes, evaluates degree of correlation among the plurality of the temporary separated signals generated in the temporary separation processing Pr2 by the separation operation processing part 11 (an example of the sound source separation means). Then, the initial matrix determination part 26, based on a result of the evaluation, selects a matrix to be the initial matrix from the plurality of the candidate matrixes Woi (an example of the initial matrix determination means). It is also possible to select a matrix to be the initial matrix from the plurality of the temporary separating matrixes corresponding to each of the plurality of the candidate matrixes Woi based on the evaluation result of correlation.

For example, by the correlation evaluation part 25, based on a known correlation function, a correlation coefficient among the temporary separated signals is calculated. Then, the temporary separating matrix at the time of obtaining the smallest correlation coefficient (at the time of obtaining the lowest correlation), or the candidate matrixes Woi corresponding to the temporary separating matrix is selected (determined) as the initial matrix to be used for learning calculation.

The separated signals yi(t) used for an correlation evaluation by the correlation evaluation part 25 are signals stored in the separated signal buffer 24.

Then, at a time (the time of time T2) when the first input signals Si1 (mixed sound signals xi(t)) of the amount of the first set time length Tw1 after the start of the processing are stored in the input signal buffer 21, the learning operation part 12 carries out a normal learning processing Pr4 which is a processing to calculate a separating matrix W which is used for real time sound source separation processing. In the drawing, the time necessary for a processing of the normal learning processing Pr4 is shown as Td (<Tw1).

In a first normal learning processing Pr4, the initial matrix determined in the initial matrix determination processing Pr3 is used as an initial value of the separating matrix W, and further, the first input signals Si1 (mixed sound signals) of the amount of the first set time length Tw1 are used as learning signal. Then, the separation operation processing part 11 (an example of the separating matrix initial learning means) carries out a learning calculation of the separating matrix W based on the ICA-BSS sound source separation method, and as a result of the learning calculation, the separating matrix W is calculated (an example of the separating matrix initial learning means, the period of time from T2 to T21 in the drawing).

Subsequently, each time new input signals Si2, Si3, (mixed sound signals xt(t)) of the amount of the first set time length Tw1 are stored in the input signal buffer 21, the learning operation part 12 uses each of the input signals Si2, Si3, . . . of the amount of the first set time length Tw1 as learning signals, and sequentially carries out the normal learning processing Pr4 (each of the period of time from T3 to T31, from T4 to T41, . . . in the drawing). Then, the learned separating matrix obtained by the previous learning calculation is used as the initial matrix.

From the time when the first normal learning processing Pr4 by the learning operation part 12 is finished (from the time T21), the separation operation processing part 11 sequentially carries out a normal separation processing Pr5 for generating external output (normal) separated signals yi(t) (corresponds to the sequential sound source separation processing). By carrying out a matrix calculation using the latest separating matrix W sequentially calculated (learned) in the normal learning processing Pr4 to the input signals (mixed sound signals xi(t)) sequentially input from the microphones 111 and 112, the separated signals yi(t) are generated.

During the execution of the normal separation processing Pr5, the input selection switch 22 is set (controlled) so that the input signals sequentially input from the microphones 111 and 112 are input in the separation operation processing part 11. Further, during the execution of the normal separation processing Pr5, the output selection switch 23 is set (controlled) so that the separated signals yi(t) generated in the separation operation processing part 11 in real time are externally output.

The separating matrix W used in the normal separation processing Pr5 is updated to the latest separating matrix obtained by a new learning each time the normal learning processing Pr4 based on the input signal of the amount of the first set time length Tw1 is carried out.

In parallel with the normal separation processing Pr5, the correlation evaluation part 25 regularly carries out a separated signal evaluation processing Pr6 (the period of time from T31 to T32, from T41 . . . in the drawing). For example, each time the separated signal yi(t) of the amount of the first set time length Tw1 is generated in the normal separation processing Pr5 (sequential sound source separation processing)(that is, each time the normal learning processing Pr4 updates the separating matrix W), the separated signal evaluation processing Pr6 is carried out.

In the separated signal evaluation processing Pr6, the correlation evaluation part 25 calculates a correlation coefficient among the plurality of the separated signals yi(t) generated in the normal separation processing Pr5 (sequential sound source separation processing) by the separation operation processing part 11 (an example of the evaluation of degree of correlation). Then, it is determined whether the correlation coefficient indicates a correlation exceeding a predetermined set level (an example of the second correlation evaluation means).

The separated signal yi(t) used in the separated signal evaluation processing Pr6 by the correlation evaluation part 25 is a signal stored in the separated signal buffer 24.

In the separated signal evaluation processing Pr6, if it is determined that the correlation is a degree that the correlation coefficient among the separated signals yi(t) does not exceed the set level, the normal separation processing Pr5 and regular normal learning processing Pr4 are continued to be performed.

On the other hand, in the separated signal evaluation processing Pr6, if it is determined that the correlation coefficient among the separated signals yi(t) indicates a correlation exceeds the set level, although not shown in FIG. 2, based on the latest input signals of the amount of the second set time length Tw2 at the time stored in the input signal buffer 21, the above-described temporary learning processing Pr1, the temporary separation processing Pr2, and the initial matrix determination processing Pr3 are further carried out. Then, the separating matrix W in the learning operation part 12 is initialized to the initial matrix obtained by the further carried out initial matrix determination processing Pr3. The initial matrix determination part 26 is controlled so that the normal learning processing Pr5 (an example of the processing of separating matrix initial learning means) from the first time is carried out based on the initial matrix (an example of the separating matrix initialization means).

As described above, in the sound source separation apparatus X, at the time of the start of a sound source separation processing and when a sufficient sound source separation performance is not obtained (when correlation among separated signals is high), by the temporary learning processing Pr1, the temporary separation processing Pr2, and the initial matrix determination processing Pr3, based on a plurality of candidate matrixes Woi stored in advance (candidates of separating matrixes corresponding to a plurality of acoustic environments expected in advance), an initial matrix which corresponds to an acoustic environment of the time is determined. As a result, the number of sequential operations necessary to converge the separating matrix W can be reduced. Accordingly, while the operation load of the separating matrix W is reduced, the sound source separation performance can be increased as much as possible. Especially, in a case in which an acoustic environment is changed, or the like, because an initialization of a separating matrix is carried out based en an evaluation result of correlation of separated signals, it can be prevented that a learned result of the separating matrix to be a local solution.

Further, in the temporary learning processing Pr1, although learning calculation is performed to each of the plurality of candidate matrixes Woi, the time length Tw2 (the second set time length) of input signals (mixed sound signals) used for the learning is set to be much shorter than the time length Tw1 (the first set time length) of input signals used for a general normal learning processing Pr4, operation load is reduced. As a method to reduce the operation load of the temporary learning processing Pr1, in addition to setting the time length Tw2 of input signals to be short, it is also possible to set the number of repeat calculation in learning calculation to be the number smaller than that of the normal learning processing Pr4.

Further, because the input signal buffer 21 which temporarily stores the input signals (mixed sound signals) is provided and with respect to each of the candidate matrixes Woi, a learning calculation and a separation processing is carried out by using the same input signals (the input signals of the amount of the time length Tw2 from the time T1 in FIG. 2) in the temporary learning processing Pr1 (temporary separating matrix calculation processing) and the temporary separation processing Pr2, the conditions which are to be a premise when comparing evaluation results of correlation degree are satisfied. As a matter of course, even if the time of input signals to be used somewhat differ, an effective result can be obtained.

What is claimed is:

1. A sound source separation apparatus comprising:
a plurality of sound input means for receiving a plurality of mixed sound signals, sound source signals from a plurality of sound sources being overlapped in each of the mixed sound signals;
storage means for storing in advance a plurality of candidate matrixes to which predetermined matrix elements are set;
initial matrix determination means for determining an initial matrix used for a learning calculation of a separating matrix by a blind source separation based on independent component analysis according to the plurality of the candidate matrixes;
separating matrix initial learning means for performing the learning calculation of the separating matrix by using the initial matrix and the plurality of mixed sound signals of a predetermined time length; and
sequential sound source separation means for sequentially generating a plurality of separated signals corresponding to the sound source signals by performing a matrix calculation using the separating matrix.

2. The sound source separation apparatus according to claim 1, wherein the plurality of the candidate matrixes are separating matrixes obtained by learning calculations according to the blind source separation based on independent component analysis by using each of the mixed sound signals if conditions of the sound sources differ.

3. The sound source separation apparatus according to claim 1, further comprising:
temporary separating matrix calculation means for calculating temporary separating matrixes by performing learning calculations of the separating matrixes according to the blind source separation based on independent component analysis using the candidate matrixes and the plurality of the mixed sound signals of a predetermined time length with respect to each of the plurality of the candidate matrixes;
temporary sound source separation means for generating a plurality of temporary separated signals corresponding to the sound source signals from the plurality of the mixed sound signals by matrix calculations using the temporary separating matrixes with respect to each of the temporary separating matrixes; and
a first correlation evaluation means for evaluating a degree of correlation among the plurality of the temporary separated signals generated by the temporary sound source separation means with respect to each of the temporary separating matrixes;
wherein the initial matrix determination means selects a matrix to be the initial matrix from the plurality of the candidate matrixes or the temporary separating matrixes corresponding to each of the candidate matrixes based on a evaluation result of the first correlation evaluation means.

4. The sound source separation apparatus according to claim 3, wherein the time length of the mixed sound signals used by the temporary separating matrix calculation means is set to be shorter than the time length of the mixed sound signals used by the separating matrix calculation means.

5. The sound source separation apparatus according to claim 3, further comprising:
mixed sound signal storage means for storing the plurality of the mixed sound signals of the predetermined time length;
wherein the temporary separating matrix calculation means calculates the temporary separating matrixes by using the same mixed sound signals stored on the mixed sound signal storage means with respect to each of the plurality of the candidate matrixes.

6. The sound source separation apparatus according to claims 1, wherein the processing by the initial matrix determination means and the separating matrix initial learning means is carried out at least at a time of a start of sound source separation processing by the sound source separation apparatus.

7. The sound source separation apparatus according to claims 1, further comprising:
a second correlation evaluation means for evaluating a degree of correlation among the plurality of the separated signals generated by the sequential sound source separation means; and
separating matrix initialization means for executing the processing by the initial matrix determination means and the separating matrix initial learning means based on a evaluation result of the second correlation evaluation means.

8. A sound source separation method comprising the steps of:
receiving a plurality of mixed sound signals, sound source signals from a plurality of sound sources being overlapped in each of the mixed sound signals;
storing in advance a plurality of candidate matrixes to which predetermined matrix elements are set;
determining an initial matrix used for a learning calculation of a separating matrix by a blind source separation based on independent component analysis according to the plurality of the candidate matrixes;
performing the learning calculation of the separating matrix by using the initial matrix and the plurality of mixed sound signals of a predetermined time length; and
sequentially generating a plurality of separated signals corresponding to the sound source signals by performing a matrix calculation using the separating matrix.
